(19) United States
(12) Patent Application Publication
(10) Pub. No.: US 2010/0079670 A1
(43) Pub. Date: Apr. 1, 2010

(54) MULTI-VIEW CONTENT CASTING SYSTEMS AND METHODS

(75) Inventors: Kristopher T. Frazier, Frisco, TX (US); John P. Valdez, Flower Mound, TX (US); Ryan Trees, Farmers Branch, TX (US); Brian Roberts, Frisco, TX (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES, LLC, Temple Terrace, FL (US)

(21) Appl. No.: 12/241,980

(22) Filed: Sep. 30, 2008

(51) Int. Cl. H04N 5/445

(52) U.S. Cl. 348/564; 348/E05.099

(57) ABSTRACT

In an exemplary method, a plurality of video feeds carrying data representative of a plurality of event views is transformed into at least one video signal. The at least one video signal is distributed over at least one television carrier channel associated with a television programming channel and is received and processed by a receiver, including selectively providing one of the event views for display. In certain embodiments, user input is received with the receiver and different ones of the events views are toggled between for display in association with the television programming channel and in response to the user input. In certain embodiments, the event views include a plurality of player views associated with a multiplayer video game session.

### BACKGROUND INFORMATION

The video game industry has enjoyed significant growth in recent years. In particular, online gaming, which allows users to play video games interactively over the Internet, has blossomed into a large industry. In order to participate in a typical online game session, a person may install a video game application onto a gaming device configured to communicate with a gaming server and to perform gaming operations. The person may then use the gaming device to join and participate in a multiplayer online game session hosted by the gaming server.

However, distribution of gaming content generated for a game session is limited. Typically, such gaming content is provided to and rendered exclusively by gaming devices actively participating in the game session.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary multi-view content casting system.

FIG. 2A illustrates an exemplary gaming based implementation of the system of FIG. 1.

FIG. 2B illustrates an exemplary camera based implementation of the system of FIG. 1.

FIG. 3 illustrates an exemplary content convergence subsystem.

FIG. 4 illustrates a portion of an exemplary video signal.

FIG. 5 illustrates an exemplary server based implementation of a rendering module and a transformation module.

FIG. 6 illustrates an exemplary content distribution subsystem.

FIG. 7 illustrates an exemplary remote control user input device.

FIG. 8 illustrates exemplary receiver tuning and display processing patterns.

FIG. 9A illustrates an exemplary flow of gaming content.

FIG. 9B illustrates another exemplary flow of gaming content.

FIGS. 10A-10E illustrate several exemplary views displayed in a graphical user interface.

FIG. 11 illustrates an exemplary multi-view content casting method.

### DETAILED DESCRIPTION OF PREFERRED EMBODIMENTS

Exemplary multi-view content casting systems and methods are described herein. In certain embodiments, multi-view content associated with an event (e.g., player views associated with a multiplayer video game session) may be transformed into at least one video signal that may be distributed, received, and used to toggle between different views of the event.

An exemplary method includes transforming a plurality of video feeds carrying data representative of a plurality of event views into at least one video signal, distributing the at least one video signal over at least one television carrier channel associated with a television programming channel, and receiving and processing the at least one video signal with a receiver to selectively provide one of the event views for display. In certain embodiments, user input is received with the receiver and different ones of the events views are toggled between for display in association with the television programming channel and in response to the user input. In certain embodiments, the event views include a plurality of player views associated with a multiplayer video game session.

Another exemplary method includes combining a plurality of video feeds representative of a plurality of event views into a single video signal and providing the video signal for distribution over a television carrier channel. In certain embodiments, the method further includes distributing the video signal to a receiver over the television carrier channel, and selectively processing the video signal with the receiver to selectively provide at least one of the event views for display.

Another exemplary method includes transforming a plurality of video feeds carrying data representative of a plurality of event views into a plurality of video signals and providing the video signals for distribution over a plurality of television carrier channels associated with a television programming channel. In certain embodiments, the method further includes distributing the video signals to a receiver over the television carrier channels, instructing the receiver to alternate tuning between each of the television carrier channels in accordance with a set pattern, and instructing the receiver to selectively perform display processing for only one of the video signals based on the set pattern.

An exemplary system includes a content convergence subsystem configured to transform content data into at least one video signal carrying data representative of a plurality of event views and a content distribution facility configured to receive the at least one video signal from the content convergence subsystem and to distribute the at least one video signal to a receiver over at least one television carrier channel associated with a television programming channel, and in which the at least one video signal is configured to be received and selectively processed by the receiver such that one of the event views is selectively provided for display in association with the television programming channel. In certain embodiments, the at least one video signal is configured to be selectively processed by the receiver to toggle between providing different event views for display in association with the television programming channel and in response to user input received by the receiver.

Exemplary embodiments of multi-view content casting systems and methods will now be described in more detail with reference to the accompanying drawings.

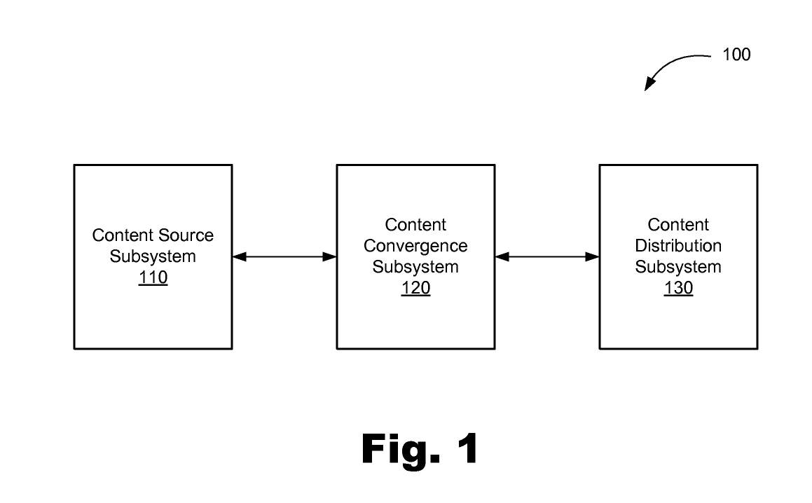

FIG. 1 illustrates an exemplary multi-view content casting system 100 (or simply “system 100”). As shown in FIG. 1, system 100 may include a content source subsystem 110, a content convergence subsystem 120, and a content distribution subsystem 130. Content source subsystem 11 0 and content convergence subsystem 120 may be configured to communicate with one another, and content distribution subsystem 130 and content convergence subsystem 120 may be configured to communicate with one another, as shown in FIG. 1. Communications between and/or within the subsystems 110, 120, and 130 may be performed using any communication platforms and technologies suitable for transporting data, content (e.g., video), content metadata, and/or other communications, including known communication technologies, devices, media, and protocols supportive of remote or local data communications. Example of such communication technologies, devices, media, and protocols include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Time Division Multiplexing (“TDM”) technologies, Short Message Service (“SMS”), Multimedia Message Service (“MMS”), Evolution Data Optimized Protocol (“EVDO”), radio frequency (“RF”) signaling technologies, signaling system seven (“SS7”) technologies, Ethernet, in-band and out-of-band signaling technologies, Fiber-to-the-premises (“FTTP”) technologies, Passive Optical Network (“PON”) technologies, and other suitable communications technologies.

In some examples, system 100, or one or more components of system 100, may include any computer hardware and/or instructions (e.g., software programs), or combinations of software and hardware, configured to perform the processes described herein. In particular, it should be understood that components of system 100 may include and/or may be implemented on one physical computing device or may include and/or may be implemented on more than one physical computing device. Accordingly, system 100 may include any number of computing devices, and may employ any number of computer operating systems.

Accordingly, the processes described herein may be implemented at least in part as computer-executable instructions, i.e., instructions executable by one or more computing devices, tangibly embodied in a computer-readable medium. For example, such instructions may include one or more software, middleware, and/or firmware application programs tangibly embodied in one or more computer-readable media and configured to direct one or more computing devices to perform one of more of the processes described herein. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Content source subsystem 110 may be configured to provide content data to content convergence subsystem 120. The content data may include data representative of or otherwise associated an event and may include data representative of or otherwise associated with multiple views of the event (“event views”). Each event view may include video images of and/or data associated with a different vantage point or viewing perspective of an event. For example, an event may include a video game session (e.g., a multiplayer online game session) and the event views may include player-specific views (“player views”) of the game session. In other examples, the event views may include multiple captured video camera views (“camera views”) of an event such as a sporting event, concert, etc. These examples of events and views are illustrative only. In other examples, the content data may be representative of or otherwise associated with other views of another event.

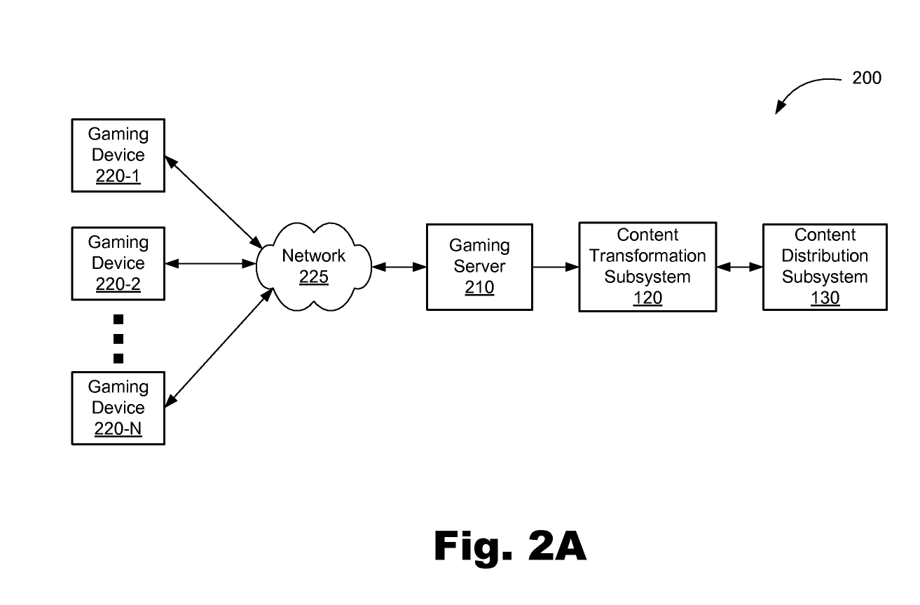

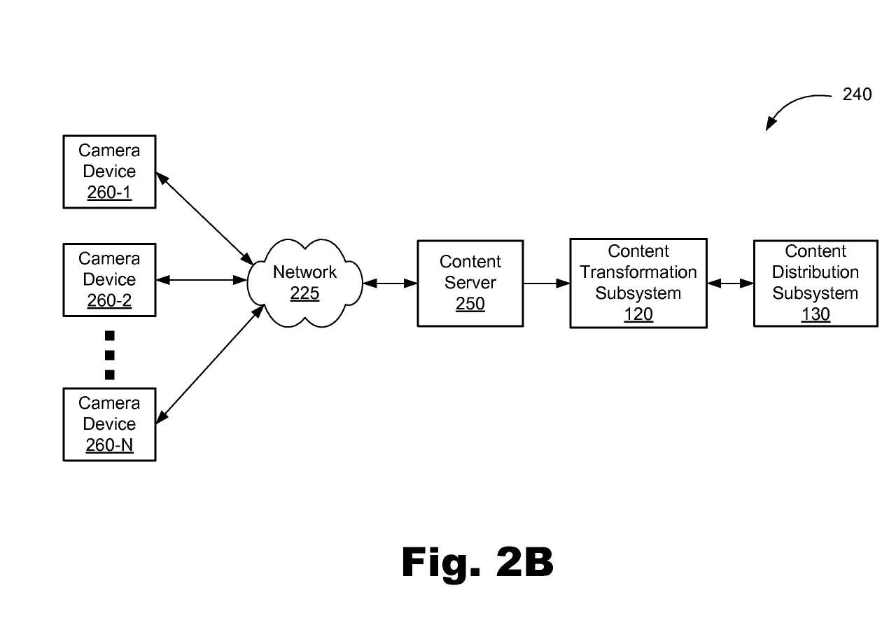

FIG. 2A illustrates an exemplary gaming based implementation 200 of system 100 in which content source subsystem 110 may include or be implemented within at least one gaming server 210 configured to communicate with gaming devices 220-1 through 220-N (collectively “gaming devices 220”) by way of a network 225. Network 225 may include one or more networks, including, but not limited to, gaming networks, wireless networks, mobile telephone networks (e.g., cellular telephone networks), closed media networks, the Internet, intranets, local area networks, public networks, private networks, optical fiber networks, broadband networks, narrowband networks, voice communications networks, Voice over Internet Protocol “(VoIP”) networks, Public Switched Telephone Networks (“PSTN”), and any other networks capable of carrying data representative of gaming content and/or data and communications signals between gaming server 210 and gaming devices 220. Communications between the gaming server 210 and the gaming devices 220 may be transported using any one of above-listed networks, or any combination or sub-combination of the above-listed networks. In certain exemplary embodiments, network 225 includes the Internet, and the gaming server 210 is configured to host one or more gaming events such as one or more online multi-player video game sessions. While FIG. 2A illustrates a single gaming server 210, this is illustrative only. Gaming server 210 may include one or more gaming servers or server configurations.

Gaming device 220 may include any device configured to perform one or more gaming operations, including receiving and processing user input, processing gaming data, communicating with and/or transmitting and receiving gaming data to/from gaming server 210 by way of network 225, and generating and providing user output, including rendering and presenting game views in a graphical user interface. Gaming device 220 may include, but is not limited to, a computing device (e.g., a desktop or laptop computer), a communication device, a wireless computing device, a wireless communication device (e.g., a mobile phone), a personal digital assistant, a gaming console, a handheld gaming device, and any other device configured to perform one or more gaming operations.

In certain exemplary embodiments, gaming device 220 may include gaming software or other computer-readable instructions (e.g., a gaming application program) tangibly embodied in a computer-readable medium and configured to direct a processor to perform one or more gaming operations. In other embodiments, gaming device 220 may include a user interface that may be utilized to access and operate gaming software or other instructions stored at gaming server 210.

A gaming device 220 may be associated with a user, who is typically a player who may utilize the gaming device 220 to participate in a game session hosted by gaming server 210. When the gaming session is a multi-player game session, multiple players using multiple gaming devices 220 may participate in the game session.

During a game session, gaming data may be transmitted between gaming server 210 and one or more gaming devices 220 participating in the game session. For a multi-player game session involving a plurality of gaming devices 220, each gaming device 220 may process gaming data received from the gaming server 210, including using the gaming data to render and display one or more game views in a graphical user interface.

Game views may be player specific. For example, in a gaming session involving gaming devices 220-1, 220-2, and 220-N, gaming device 220-1 may render and present one or more player-specific game views associated with a first player, gaming device 220-2 may render and present one or more player-specific game views associated with a second player, and gaming device 220-N may render and present one or more player-specific game views associated with an N^{th} player. As mentioned above, player-specific game views may be referred to as “player views.”

Gaming server 210 may be configured to provide gaming data to content convergence subsystem 120. The gaming data may be provided in any suitable way and using any suitable technologies, including any of the communications networks and/or technologies mentioned herein. Gaming data provided to content convergence subsystem 120 may include data representative of or otherwise associated with multiple player views corresponding to a game session.

In certain embodiments, the providing of gaming data to the content convergence subsystem 120 may be selectively activated and deactivated. For example, a participant in or an operator of a game session may select an option for casting (e.g., broadcasting, multicasting, or narrowcasting) a game session by way of content distribution subsystem 130. With a selection made to distribute a game session, gaming server 210 may be configured to provide gaming data for the game session to content convergence subsystem 120.

In certain embodiments, a participant in or an operator of a game session may also select one or more distribution settings for the game session. For example, a programming channel or service (e.g., a television programming channel or service such as a gaming programming channel or service made available by content distribution subsystem 130) may be selected for distribution and/or viewing of the game session. A television programming channel will be described in more detail further below.

While FIG. 2A illustrates an exemplary gaming based content source from which gaming data may be received by content convergence subsystem 120, in other implementations content data may be received from other sources. For example, FIG. 2B illustrates an exemplary camera based implementation 240 of system 100. In implementation 240, content source subsystem 110 may include or be implemented within at least one content server 250 configured to communicate with camera devices 260-1 through 260-N (collectively “camera devices 260”) by way of network 225.

A camera device 260 may include any device configured to capture and provide signals and/or data representative of video images. For example, camera device 260 may include a device configured to capture video of a sporting event, concert, or other event. In certain examples, multiple camera devices 260 may be utilized to capture video of an event from multiple angles or locations. Accordingly, different camera views from different vantage points of the event may be captured and provided by the camera devices 260. The camera devices 260 may provide signals and/or data representative of the corresponding captured camera views to content server 250.

Content server 250 may be configured to provide camera data representative of the multiple different captured camera views to content convergence subsystem 120. In certain embodiments, the providing of camera data to the content convergence subsystem 120 may be selectively activated and deactivated. For example, an operator of content server 250 may select an option for distributing video content of an event by way of content distribution subsystem 130. With a selection made to distribute the video content, content server 250 may be configured to provide camera data including data representative of or otherwise associated multiple camera views of an event to content transformation subsystem 120. In certain alternative embodiments, camera devices 260 may be configured to provide camera data representative of multiple camera views directly to content convergence subsystem 120.

Content convergence subsystem 120 may receive and process content data provided by content source subsystem 110. Processing may include transforming the content data representative of or otherwise associated with multiple views of an event to at least one video signal, which may be provided to content distribution subsystem 130 for distribution.

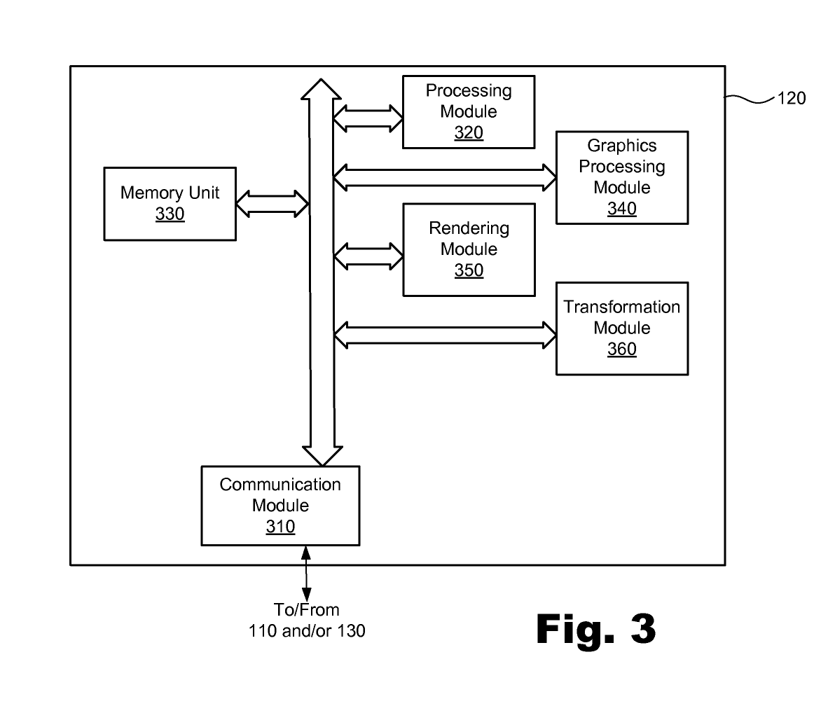

FIG. 3 illustrates an exemplary content convergence subsystem 120. The components of content convergence subsystem 120 may include or be implemented as hardware, computing instructions (e.g., software) embodied on at least one computer-readable medium, or a combination thereof. In certain embodiments, for example, one or more components of content convergence subsystem 120 may include or be implemented on one or more servers configured to communicate with content source subsystem 110 and/or content distribution subsystem 130. While an exemplary content convergence subsystem 120 is shown in FIG. 3, the exemplary components illustrated in FIG. 3 are not intended to be limiting. Indeed, additional or alternative components and/or implementations may be used.

As shown in FIG. 3, content convergence subsystem 120 may include a communication module 310, which may be configured to communicate with content source subsystem 110 and/or content distribution subsystem 130, including receiving content data (e.g., gaming data and/or camera data) from content source subsystem 110 and providing one or more generated video signals to content distribution subsystem 130 for distribution. The communication module 310 may include and/or support any suitable communication platforms and technologies for communicating with content source subsystem 110 and/or content distribution subsystem 130.

Content convergence subsystem 120 may include a processing module 320 configured to control and/or perform operations of the content convergence subsystem 120. Processing module 320 may execute or direct execution of operations in accordance with computer-executable instructions stored to a computer-readable medium such as a memory unit 330.

Memory unit 330 may include one or more data storage media, devices, or configurations and may employ any type, form, and combination of electronic storage media. For example, the memory unit 330 may include, but is not limited to, a hard drive, network drive, flash drive, magnetic disc, optical disc, random access memory (“RAM”), dynamic RAM (“DRAM”), other non-volatile and/or volatile storage unit, or a combination or sub-combination thereof. Memory unit 330 may temporarily or permanently store any suitable type or form of electronic data, including content data such as gaming data. In certain embodiments, memory unit 330 may be used to buffer data for processing.

Content convergence subsystem 120 may include a graphics processing module 340 configured to perform one or more graphics operations, including processing content data and rendering one or more event views (e.g., player views or camera views of an event) from the content data. Graphics processing module 340 may include one or more graphics cards and/or graphics processing units.

As shown in FIG. 3, content convergence subsystem 120 may include a rendering module 350 and a transformation module 360, each of which may include or be implemented as hardware, computing instructions (e.g., software) tangibly embodied on a computer-readable medium, or a combination of hardware and computing instructions configured to perform one or more of the processes described herein.

Rendering module 350 may be configured to use received content data to render, or direct graphics processing module 340 to render, video feeds representative of respective event views. The video feeds may be rendered from the content data in any suitable way and/or using any suitable technologies. In certain embodiments, rendering module 350 may include one or more applications configured to process content data and to direct graphics processing module 340 to generate raw video feeds for the event views from the content data. For example, rendering module 350 may include a gaming application configured to direct graphics processing module 340 to generate raw video gaming feeds for a game session from the gaming data provided by gaming server 210. Each video feed may correspond to a player view of the game session.

In certain alternative embodiments, rendering module 350 may be omitted from content convergence subsystem 120 and/or one or more rendering operations bypassed, such as when content data includes already-rendered video feeds representative of event views. As an example, gaming server 210 may be configured to render video feeds of player views from gaming data and to provide the player view video feeds to content convergence subsystem 120. In such an example, rendering module 350 may be omitted from content convergence subsystem 120 and/or rendering operations may be bypassed within content convergence subsystem 120.

Transformation module 360 may be configured to receive and process multiple video feeds representative of multiple respective event views, including video feeds rendered by rendering module 350 or video feeds received directly from content source subsystem 110. In certain examples, processing of the video feeds may include transforming the video feeds from one format to another format suitable for distribution by content distribution subsystem 130. For instance, the video feeds may be converted to television standards based signals. Examples of television standards based signals include, but are not limited to, a National Television Standards Committee (“NTSC”) based signal, an Advanced Television Systems Committee (“ATSC”) based signal, a Phase Alternating Line (“PAL”) based signal, a SECAM based signal, and a Digital Video Broadcasting (“DVB”) based signal.

Transforming of video feeds may include generating at least one video signal and inserting data representative of the video feeds into the video signal(s). In certain embodiments, the transforming may include combining the video feeds into a single video signal. In certain other embodiments, the transforming may include inserting the video feeds into a plurality of video signals. For example, each video feed may be inserted or otherwise transformed into a respective video signal. In certain other embodiments, these two ways of transforming video feeds into at least one video signal may be combined such that video feeds are transformed into multiple video signals and such that at least one video signal includes data representative of multiple event views. Each of these exemplary ways of transforming video feeds into at least one video signal will now be described in more detail.

In certain embodiments, transforming video feeds may include generating a single video signal and combining multiple video feeds carrying data representative of multiple event views into the video signal. The video signal may be in any format suitable for distribution by content distribution subsystem 130 and capable of representing multiple event views. In certain embodiments, for example, the video signal may be defined in accordance with a television signals standard, such as any of those mentioned herein, to create a television standards based signal suitable for distribution by content distribution subsystem 130.

Hence, in certain examples, multiple video feeds corresponding to multiple event views are combined into a single video signal that is suitable for distribution over a television carrier channel suitable for transporting a television signal in accordance with a television signaling standard. For instance, a television carrier channel may include a select band of carrier frequencies used for transporting television content. Accordingly, a video signal generated by transformation module 360 may represent multiple event views and may be defined in accordance with a television signal standard. As an example, the video signal may comprise an ATSC, NTSC, or DVB based signal including content representative of multiple event views.

Combining multiple video feeds into a single video signal may be accomplished in any suitable way. In certain embodiments, for example, combining multiple video feeds corresponding to multiple event views into a video signal may include multiplexing (e.g., time division multiplexing) the video feeds into the video signal based on frame rate. As an example, content distribution subsystem 130 may be configured to distribute video content using a video signal having a particular frame rate, such as one hundred twenty frames per second (120 frames/sec). This frame rate may be divided among the multiple video feeds . For instance, when there are four video feeds to be combined into a video signal having a frame rate of one hundred twenty frames per second (120 frames/sec), the frame rate of the video signal may be divided by four and each of the video feeds multiplexed into the video stream at a frame rate of thirty frames per second (30 frames/sec). Accordingly, the video signal may include multiple sets of frames multiplexed in the video signal and identifiable for selectively processing one of the sets of frames for display of a corresponding event view. In the present example, every fourth frame in the video signal may belong to a set of frames associated with a particular video feed and an event view corresponding to the video feed. For example, a first set of frames (e.g., frames 1, 5, 9, etc.) may be associated with a first event view, a second set of frames (e.g., frames 2, 6, 10, etc.) may be associated with a second event view, a third set of frames (e.g., frames 3, 7,11, etc.) may be associated with a third event view, and a fourth set of frames (e.g., frames 4, 8, 12, etc.) may be associated with a fourth event view.

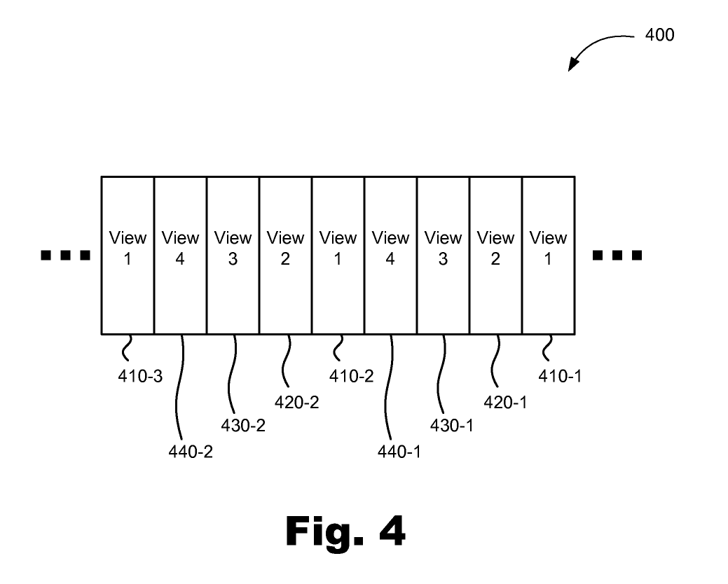

FIG. 4 illustrates a portion of an exemplary video signal 400 having four video feeds corresponding to four event views multiplexed therein. In the illustrated portion of the video signal, frames 410-1, 410-2, and 410-3 may be associated with a first event view, frames 420-1 and 420-2 may be associated with a second event view, frames 430-1 and 430-2 may be associated with a third event view, frames 440-1 and 440-2 may be associated with a fourth event view.

Transformation module 360 may be further configured to generate and provide a key associated with a video signal and for use by a receiver in selectively processing the distributed video signal. For example, the key may be used by a receiver to selectively identify and process select portions in the video signal, including identifying a set of frames associated with one of the event views represented in the video signal and selectively processing the set of frames to provide the event view for display. Accordingly, as described further below, the key may be used by a receiver to selectively process the video signal such that the receiver of the video signal may select or toggle between processing particular event views included in the video signal for display and in accordance with the key. Examples of selectively toggling between event views in a display will be described further below.

The key may be provided for distribution along with the video signal. This may be accomplished in any suitable way. In certain embodiments, for example, data representative of the key may be included in a closed captioning portion of the video signal. Hence, a receiver of the video signal may access the closed captioning data to access and use the key to selectively process the video signal. The key may be represented and distributed in any suitable way.

Content convergence subsystem 120 may be configured to provide the video signal to content distribution subsystem 130 for distribution. The providing of the video signal may be accomplished in any suitable way, including using any of the communications networks and/or technologies mentioned herein to transport the video signal from content convergence subsystem 120 to content distribution subsystem 130. Distribution and processing of a video signal by content distribution subsystem 130 will be described further below.

Alternative to or in addition to combining multiple video feeds into a single video signal as described above, in certain embodiments, transformation module 360 may be configured to transform multiple video feeds into multiple video signals configured to carry data representative of multiple event views corresponding to the multiple video feeds. In some examples, transformation module 360 may generate a video signal for each video feed. In such examples, each video signal may exclusively represent a single event view. In other examples, at least one of the generated video signals may include multiple video feeds combined therein as described above. This may allow for an increased number of event views to be distributed by content distribution subsystem 130.

Each of the video signals may be defined to be in suitable format for distribution by content distribution subsystem 130. As described above, for example, each of the video signals may be defined in accordance with a television signals standard.

In certain embodiments, multiple video signals representative of multiple event views may be associated with a content programming channel or service (e.g., a television programming channel) provided by content distribution subsystem 130. For example, the video signals may be grouped into a channel package (e.g., a digital channel package) associated with a television programming channel made available by content distribution subsystem 130. As used herein, a programming channel may refer to a grouping of one or more content carrier channels. For example, a television programming channel may include a grouping of television carrier channels associated with the television programming channel. When a user selects a television programming channel with a receiver, any of the television carrier channels associated with the television programming channel may be used to transport television video content to the receiver for viewing in association with the television programming channel. For example, a user may select television programming channel “300” and a receiver may tune to any content carrier channel (e.g., 300, 300-1, 300-2, etc.) associated with the television programming channel to receiver television video content that may be displayed in association with television programming channel “300.” With television programming channel “300” selected by a user, a receiver may tune to any of the associated television carrier channels in the foreground or the background.

As described further below, content distribution subsystem 130 may distribute video signals over respective television carrier channels associated with a television programming channel, and a receiver configured to receive a corresponding programming channel may receive and selectively process the video signals in accordance with instructions received along with the video signals, including selectively providing an event view corresponding to one of the video signals for display.

When content convergence subsystem 120 generates and provides multiple video signals, content convergence subsystem 120 may also generate and provide along with the video signals one or more instructions configured to direct processing of the video signals by content distribution subsystem 130. For example, such instructions may identify the video signals as being related to one another and/or as being related to a particular content programming channel or service (e.g., a gaming channel service) provided by content distribution subsystem 130. The instructions may be generated and provided in any suitable manner.

As described further below, content distribution subsystem 130 may be configured to use instructions received along with one or more video signals to distribute and selectively process the video signals. For example, the instructions may be distributed along with the video signals to a receiver of the video signals, and the receiver may be configured to use the instructions to selectively process the video signals, including selectively providing one of the event views for display.

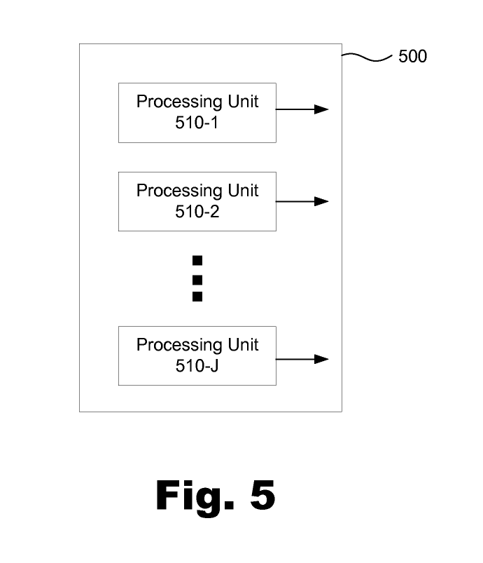

Content convergence subsystem 120 may be employ any architecture and/or technologies suitable for performing the operations described above. In certain embodiments, content convergence subsystem 120 may be implemented in a scalable fashion such that its capacity may be conveniently modified as may suit a particular application and/or as technologies are developed. For example, rendering module 350 and/or transformation module 360 may include or be implemented on one or more blade style servers or other implementations supportive of hot-swappable technologies. Each video graphics card, server, or other component may be configured to render and/or transform a certain number of video feeds. FIG. 5 illustrates an exemplary server based implementation 500 of rendering module 350 and transformation module 360. As shown, implementation may include a plurality of processing units 510-1 through 510-J (collectively “processing units”) each configured to render and/or transform a certain number of video feeds as described above. The number of processing units 510 actively rendering and/or transforming processing video feeds in implementation 500 may be dynamically modified based on demand. For example, as players participating in a multiplayer video game session changes, processing units 510 may perform processing on an as needed basis.

Content convergence subsystem 120 may provide one or more of the generated video signals carrying data representative of multiple event views to content distribution subsystem 130 for distribution. In certain embodiments, one or more video signals are grouped and provided as a grouping for distribution by content distribution subsystem 130 over one or more carrier channels (e.g., television carrier channels) associated with a programming channel or service (e.g., a gaming programming channel). In some examples, the grouping includes a single video signal including data representative of multiple event views. In other examples, the grouping included multiple video signals including data representative of multiple event views.

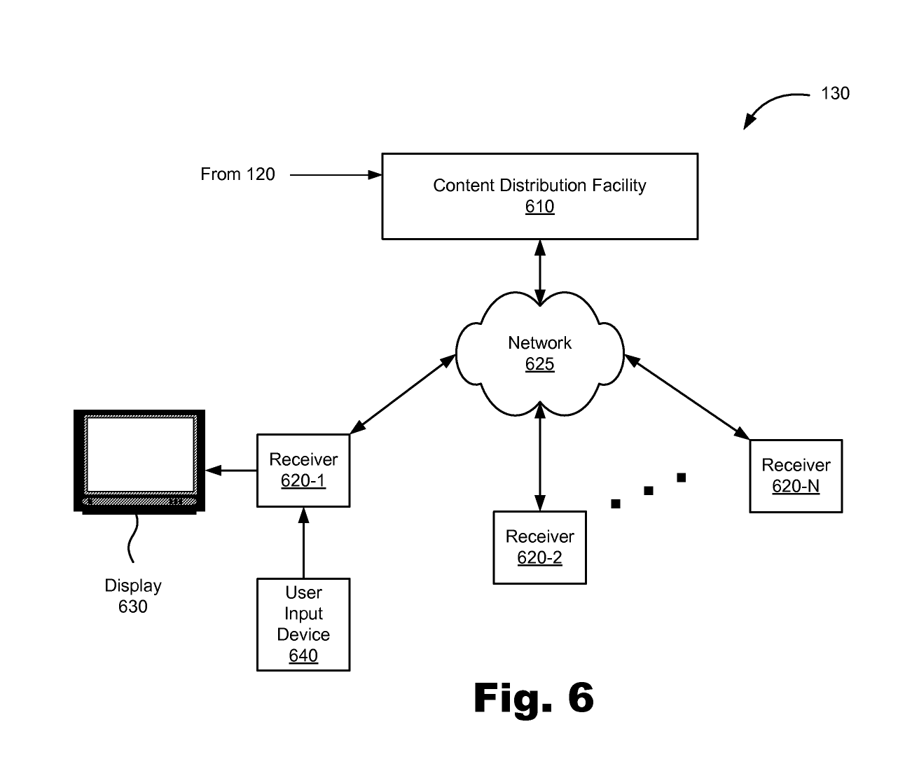

Content distribution subsystem 130 may receive one or more video signals and associated data (e.g., instructions for processing the video signals) from content convergence subsystem 120. FIG. 6 illustrates an exemplary content distribution subsystem 130. As shown in FIG. 6, content distribution subsystem 130 may include a content distribution facility 610 configured to receive one or more video signals from content convergence subsystem 120. Content distribution facility 610 may include or be implemented as computing hardware (e.g., one or more servers), computing instructions (e.g., software) embodied on at least one computer-readable medium, or a combination thereof. In certain examples, content distribution facility 610 may include a television broadcasting facility and/or television broadcasting equipment such as a head end and/or local office facility and/or equipment.

Content distribution facility 610 may be configured to distribute (e.g., broadcast, multicast, narrowcast) video signals and associated data to one or more receivers 620-1, 620-2, 620-N (collectively “receivers 620”) by way of a network 625. Content distribution facility 610 and a receiver 620 may communicate using any known communication technologies, devices, networks, media, and protocols supportive of remote communications, including, but not limited to, any of the communications networks and/or technologies mentioned herein. In certain embodiments, network 625 may include a subscriber television network (e.g., a Verizon® FIOS® network) configured to carry video signals from content distribution facility 610 to one or more receivers 620 over one or more television carrier channels.

Content distribution facility 610 may be configured to provide one or more television programming channels or services to receivers 620 over network 625. A grouping of one or more video signals received from content convergence subsystem 120 may be associated with a television programming channel or service and distributed to one or more receivers 620 in association with the programming channel or service. As an example, content distribution facility 610 may provide a gaming programming channel that a user of a receiver 620 may access to view one or more video signals related to video gaming events (e.g., video game sessions) and associated with the programming channel.

Receiver 620 may be configured to receive and process one or more video signals and associated data provided by content distribution facility 610 over network 625. Receiver 620 may include any hardware, software, and firmware, or combination or sub-combination thereof, configured to receive and process media for presentation to a user, including receiving and processing video signals for display of one or more event views represented by the video signals. For example, receiver 620 may be configured to tune to a television carrier channel to receive and process a video signal carried by the television carrier channel. To this end, receiver 620 may include one or more tuners configured to tune to one or more television carrier channels on which video content is carried from content distribution facility 610 to the receiver 620. While a tuner may be used to tune to and receive various types of content-carrying signals distributed by content distribution facility 610, receiver 620 may be configured to receive other types of signals (including media content signals, program guide data signals, and/or communication signals) from content distribution facility 610 and/or from other sources without using a tuner.

Receiver 620 may include or be implemented on any media content processing device configured to receive and to process digital and/or analog media content received from content distribution facility 610. Receiver 620 may include, but is not limited to, a set-top box (“STB”), home communication terminal (“HCT”), digital home communication terminal (“DHCT”), stand-alone personal video recorder (“PVR”), digital video recorder (“DVR”), DVD player, handheld entertainment device, video-enabled phone (e.g., a mobile phone), or other device capable of receiving and processing a video signal as described herein.

Processing a video signal may include providing video content carried by the video signal for display. In certain examples, receiver 620-1 may provide video content to a display 630, which may be configured to display the video content for viewing by a user. Display 630 may include, but is not limited to, a television, computer monitor, or other video display screen.

Receiver 620 may be at least partially controlled by a user input device 640 such as a remote control device. User input device 640 may communicate with receiver 620 using any suitable communication technologies, such as by using remote infrared signals, radio frequency signals, or other wireless link, for example.

User input device 640 may include one or more input mechanisms by which a user can provide input to and/or control receiver 620. The user may thereby access features, services, and content provided by receiver 620. In some examples, input device 640 may be configured to enable a user to control viewing options for experiencing media content provided by receiver 620, including toggling between providing different event views corresponding to one or more video signals received and processed by receiver 620 for display.

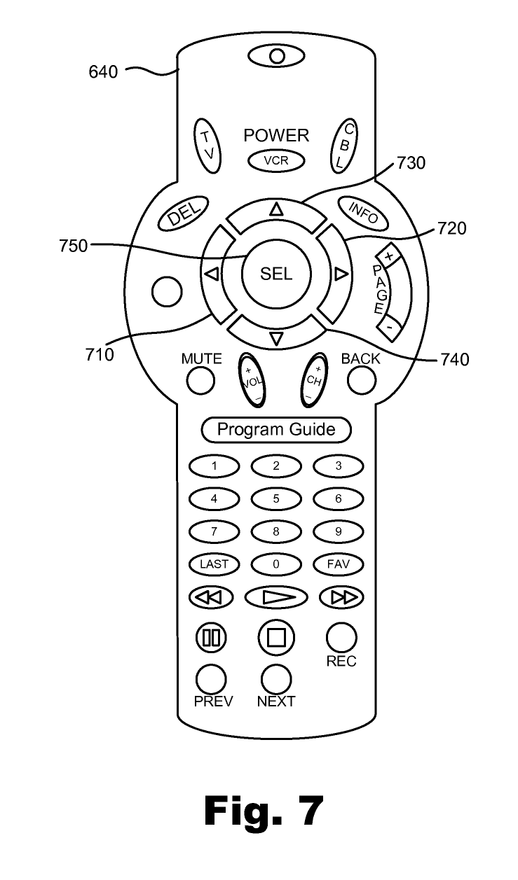

An exemplary remote control user input device 640 is illustrated in FIG. 7. As shown, input device 640 may include directional arrow buttons comprising a left arrow button 710, right arrow button 720, up arrow button 730, and down arrow button 740. Input device 640 may also include a select button 750. These buttons may be configured to enable a user to launch, close, and/or navigate through different menus, options, and event views that may be displayed by display 630. In certain embodiments, for example, a directional arrow button may be selected to toggle a display from one event view to another event view. Input device 640 shown in FIG. 7 is merely illustrative of one of the many different types of user input devices that may be used to in connection with receiver 620.

Content distribution facility 610 may be configured to provide one or more instructions to a receiver 620 for use by the receiver 620 to selectively process one or more distributed video signals. The instructions may be provided in any suitable manner. As described above, for example, a key may be provided in a closed captioning portion of a video signal and may be used by the receiver 610 to identify a select set of frames in the video signal to be processed for display. As another example, in certain embodiments, one or more television signaling standard based instructions may be used to instruct the receiver 620 to selectively process certain video signals. For instance, one or more Program and System Information Protocol (“PSIP”) commands may be used as set forth in Document A/69, titled “Program and System Information Protocol Implementation Guidelines for Broadcasters,” by the Advanced Television Systems Committee (“ATSC”), dated Jun. 25, 2002, and/or Document A/65C, titled “Program and System Information Protocol for Terrestrial Broadcast and Cable (Revision C) With Amendment No. 1,” by the Advanced Television Systems Committee (“ATSC”), dated May 9, 2006, the entire contents of which are hereby incorporated by reference. Other portions of a video signal and/or other signals (e.g., in-band or out-of-band signals) may be used to carry instructions to the receiver 620 in other embodiments.

In certain embodiments, content distribution facility 610 may instruct the receiver 610 to alternately tune between different television carrier channels and to selectively perform display processing based on a set pattern. For example, multiple video signals may be received by a receiver 620 over multiple television carrier channels. Content distribution facility 620 may instruct the receiver to alternate tuning between different ones of the carrier channels based on a set time pattern and to selectively process only one of the received video signals so as to provide a specific event view for display. This may be accomplished in any suitable manner. For example, the retuning of the receiver 620 may occur after a time period or at a frequency that is sufficient to make the retuning unnoticeable to the human eye. For example, the receiver may tune from one of the carrier channels to another of the carrier channels every twenty milliseconds (20 ms). As set forth in the above-reference PSIP Guidelines by ASIC, in some implementations there may be at least a 400 ms delay between issuance of a PSIP command and execution of the command (e.g., retuning) by a receiver 620.

The receiver 620 may be instructed to selectively process a tuned video signal for display only during specific time periods. Accordingly, as the receiver 620 alternates tuning between different carrier channels carrying different video signals as described above, the receiver 620 may selectively perform display processing only during select time periods in which the receiver 620 is tuned to a particular one of the carrier channels. In this manner, only the content included in the video signal associated with the particular carrier channel is displayed. This may allow a receiver 620 to display a select event view and to toggle the display from the select event view to another select event view.

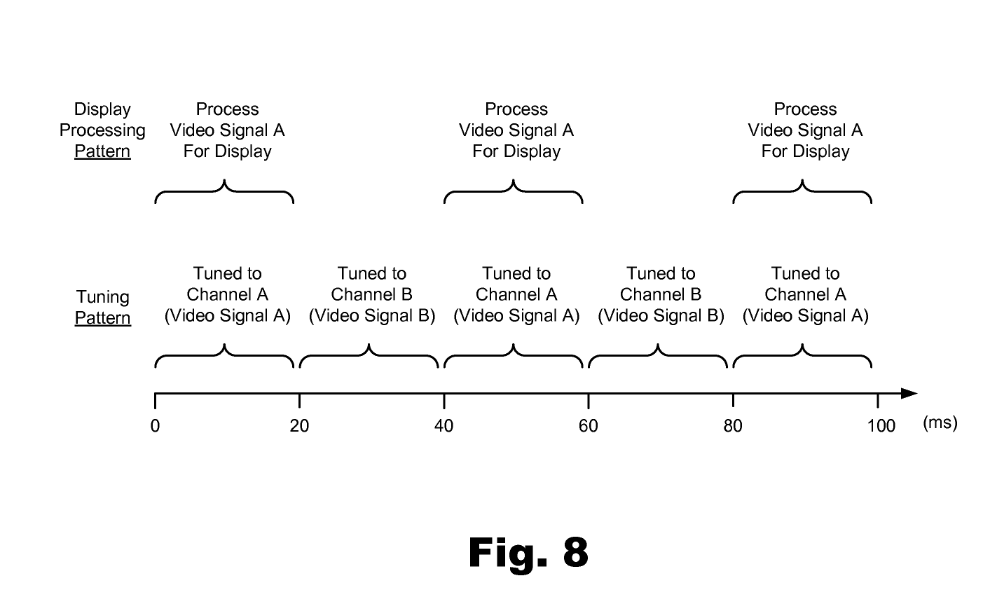

FIG. 8 illustrates an exemplary tuning pattern and display processing pattern that may be performed by a receiver 620 based on instructions received from content distribution facility 610. As shown in the illustrated example, the receiver 620 may alternately tune between different carrier channels (Channel A and Channel B) every twenty milliseconds (20 ms) in a repeating pattern. Tuning from one carrier channel to another may be performed as described above or in any other suitable manner. The twenty millisecond time periods shown in the example are illustrative only. Other suitable time periods and/or tuning patterns may be used in other examples.

In addition to alternating tuning between the carrier channels, the receiver 620 may selectively process content for display based on a set display processing pattern, e.g., only during select time periods such that only content associated with a particular one of the video signals carried by the carrier channels is displayed. In FIG. 8, display processing is performed only during time periods during which the receiver 620 is tuned to a certain carrier channel corresponding to a particular video signal (Video Signal A in the illustrated example). Accordingly, an event view represented by that video signal may be selectively displayed.

In examples in which the tuned video signal includes data representative of multiple event views, the receiver 620 may also selectively process a subset of frames within the video signal as described above to display one of the event views.

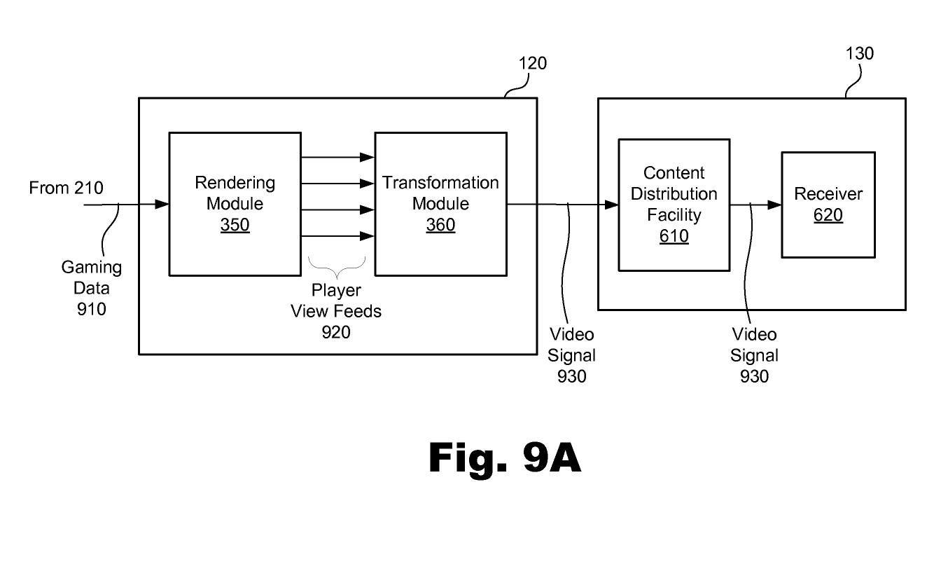

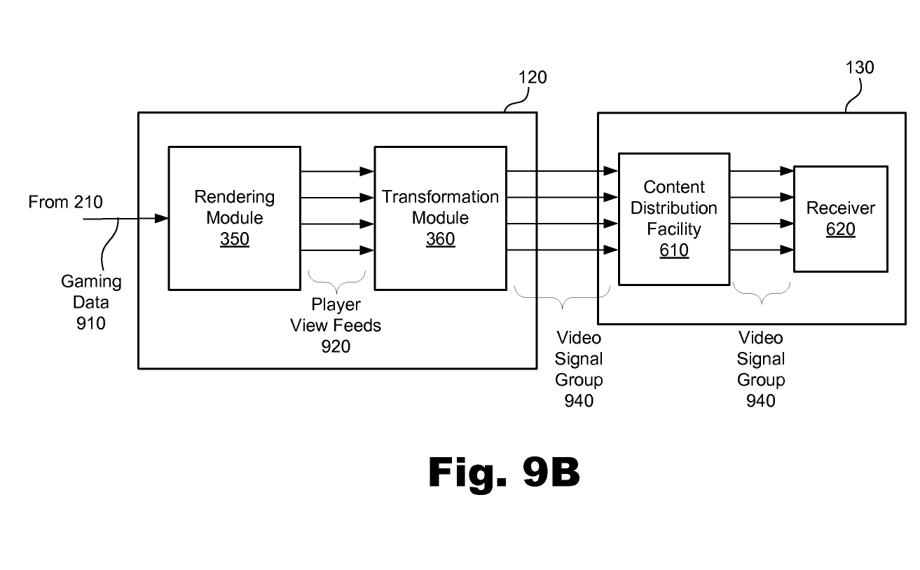

To further facilitate an understanding of system 100, an exemplary application of system 100 and several exemplary graphical user interfaces (“GUIs”) that may be displayed for viewing by a user will now be described. FIG. 9A illustrates an exemplary flow of gaming content as may occur in system 100. As shown, gaming data 910 may be received from gaming server 210. The gaming data 910 may include data associated with a game session involving multiple players. For this particular example, the gaming session is considered to involve four active players. Rendering module 350 may use the gaming data 910 to render four player view video feeds 920. Each of the feeds 920 may include data representative of one of the four player views associated with the game session. Transformation module 360 may process the player view feeds 920 as described above, including combining the four player view feeds 920 into a single video signal 930, which may be provided to content distribution facility 610 as shown in FIG. 9A. Content distribution facility 610 may distribute the video signal 930 including data representative of the four player view feeds to receiver 620, such as by distributing the video signal 930 over a television channel to which receiver 620 may tune as described above.

FIG. 9B illustrates another exemplary flow of gaming content as may occur in system 100. As shown, gaming data 910 may be received from gaming server 210. The gaming data 910 may include data associated with a game session involving multiple players. For this particular example, the gaming session is again considered to involve four active players. Rendering module 350 may use the gaming data 910 to render four player view video feeds 920. Each of the feeds 920 may include data representative of one of the four player views associated with the game session. Transformation module 360 may process the player view feeds 920 as described above, including generating four video signals and combining the video signals into a video signal group 940. Each of the video signals may carry content for a respective one of the player views. The video signal group 940 may be provided to content distribution facility 610 and associated with a television programming channel provided by content distribution facility 610. Content distribution facility 610 may distribute the video signal group 940 to receiver 620 such as by distributing each of the video signals in the group 940 over a television carrier channel for use in the television programming channel. As described above, receiver 620 may selectively and alternately tune between the television carrier channels to selectively receive and process the corresponding video signals.

Receiver 620 may selectively process one or more of the video signals received in the examples illustrated in FIGS. 9A-9B. The processing may be performed in any of the ways described above, including using a key and/or other instructions received from content distribution facility 610 to selectively process one or more video signals for selective display of one or more player views. The receiver 620 may further toggle between different ones of the player views by selectively switching display processing from one video signal and/or set of frames in the video signal to another set of frames in the video signal or to another video signal and/or set of fames in the other video signal. This may be accomplished in any of the ways described above, including in accordance with instructions provided to the receiver 620 by content distribution facility 610.

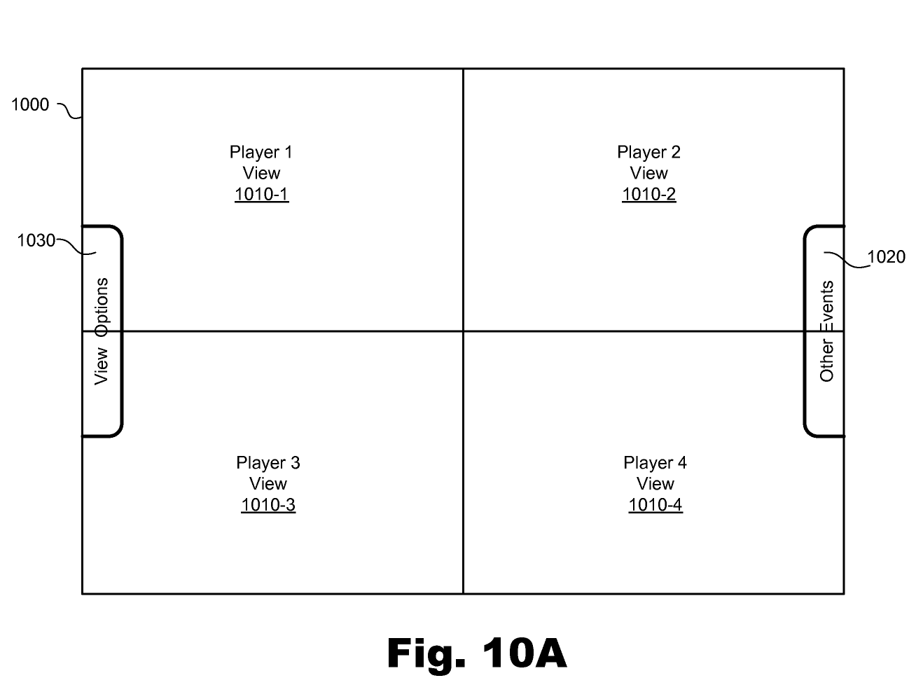

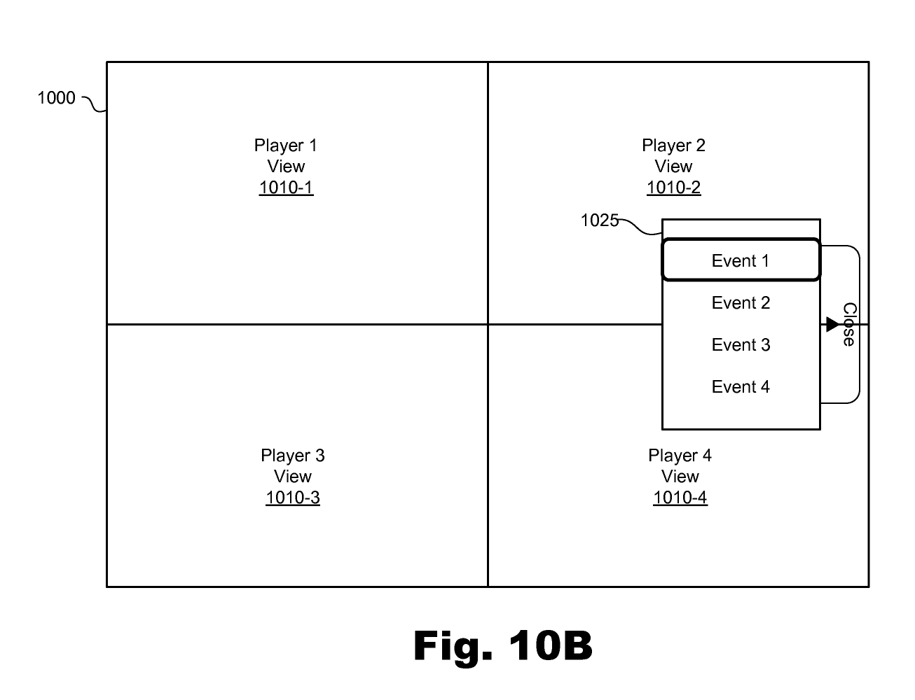

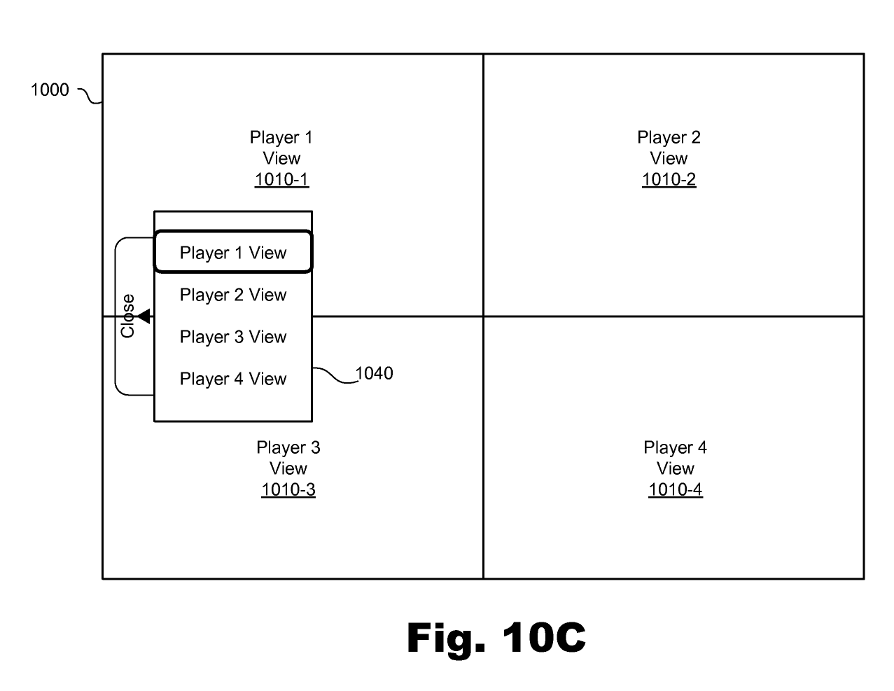

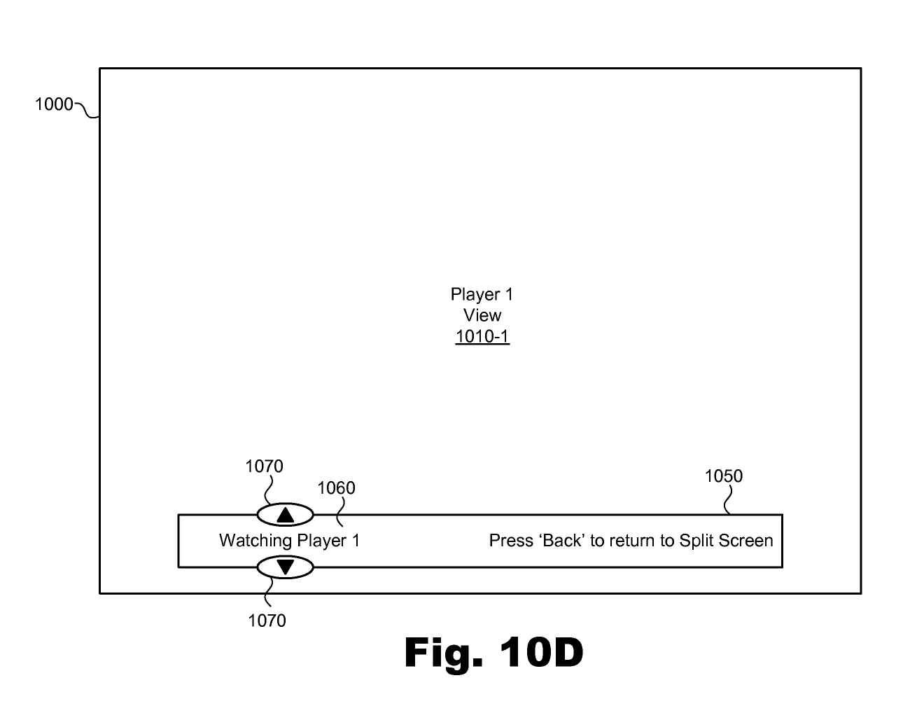

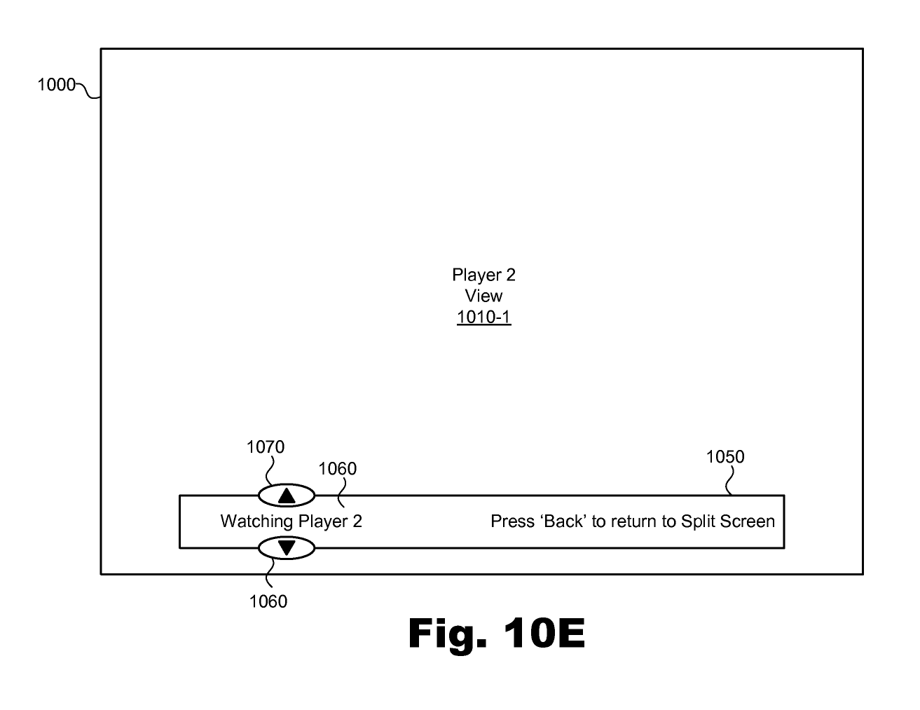

FIGS. 10A-10E illustrate exemplary display views that may be displayed in a graphical user interface in conjunction with receiver 620 selectively processing one or more video signals for selective display of one or more player views. FIG. 10A illustrates a multi-player view displayed in a graphical user interface (“GUI”) 1000. As shown, four player views 1010-1 through 1010-4 corresponding to players (e.g., “Player 1,” “Player 2,” “Player 3,” and “Player 4”) actively participating in a multi-player game session may be concurrently displayed in quadrants of GUI 1000. The split screen multi-player view shown in FIG. 10A may be displayed when a user of receiver 620 initially accesses a particular programming channel or service (e.g., a gaming programming channel) provided by content distribution facility 610.

GUI 1000 may include one or more tools for controlling the view shown in GUI 1000. For example, GUI 1000 may include an “other events” menu tab 1020. When the user provides an appropriate input command (e.g., by selecting left arrow button 710 on input device 640) the “other events” menu tab 1020 may expand into an event menu options window 1025 as shown in FIG. 10B. A user may then utilize input device 640 to scroll through the event options (e.g., different game sessions) in window 1025 and select one of the event options to instruct receiver 620 to selectively process another event. Accordingly, user may select to experience one or more views associated with another game session, including a game session associated with a different video game.

GUI 1000 shown in FIG. 10A may also include a “view options” menu tab 1030. When user provides an appropriate input command (e.g., by selecting right arrow button 720 on input device 640) the “view options” menu tab 1030 may expand into a view menu options window 1040 as shown in FIG. 10C. A user may then utilize input device 640 to scroll through the player view options in window 1040 and select one of the player view options to instruct receiver 620 to cause a corresponding player view to be displayed.

For example, when user selects the “player 1” view option in window 1040, a substantially full screen view corresponding to Player 1 may be displayed in GUI 1000 as shown in FIG. 10D. In certain embodiments, the player view shown in FIG. 9D is the same or substantially the same as a game view displayed by a gaming device 220 used by the corresponding player to participate in the game session.

The view shown in FIG. 10D may include an information pane 1050 which may include information descriptive of the current player view and/or configured to facilitate a user navigating between different player views. For example, information pane 1050 may display a player indicator 1060 indicating the player corresponding to the player view being displayed in FIG. 10D (e.g., “watching Player 1”). As another example, information pane 1050 may indicate an input mechanism (e.g., a “Back” button of input device 640) that may be used to switch from the displayed player view to the multi-player split screen view shown in FIG. 10A. As yet another example, information pane 1050 may display one or more control indicators 1070 indicating input mechanisms that may be used to switch from the currently displayed player view to another player view. In the illustrated example, the control indicators 1070 indicate that up arrow button 730 or down arrow button 740 of input device 640 may be used to switch to another player view.

When user selects down arrow button 1070 while the view shown in FIG. 10D is displayed, the view may be switched from the “player 1” view to another player view. For example, a substantially full screen player view corresponding to Player 2 may be displayed in GUI 1000 as shown in FIG. 10E. Hence, a user may utilize directional buttons of input device 640 or other input mechanisms to toggle between different player views associated with a game session. In this or similar manner, the user may be provided with significant control for viewing an event such as a game session from select views of the event.

Receiver 620 may be configured to selectively process one or more video signals having data representative of one or more player views as described above and in response to user input in order to selectively provide any of the views shown in FIGS. 10A-10E for presentation on display 630.

While the examples illustrated in FIGS. 9A-9B and FIGS. 10A-10E relate to a gaming application, system 100 may be used for other multi-view events and applications. For example, as mentioned above, instead of gaming data, content source subsystem 110 may provide camera data representative of multiple camera views of an event. Data representative of the camera views may be processed as described above such that a user of receiver 620 may selectively control display of any of the camera views on display 630.

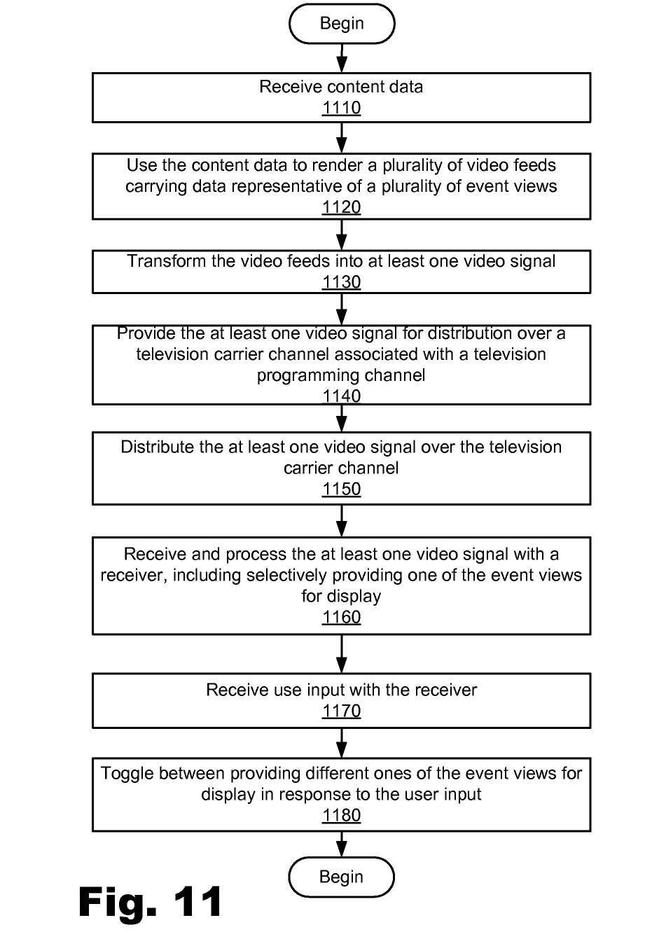

FIG. 11 illustrates an exemplary multi-view content casting method. While FIG. 11 illustrates exemplary steps according to one embodiment, other embodiments may omit, add to, reorder, and/or modify any of the steps shown in FIG. 11.

In step 1110, content data is received. Step 1110 may be performed in any of the ways described above.

In step 1120, the content data is used to render a plurality of video feeds carrying data representative of a plurality of event views. Step 1120 may be performed in any of the ways described above.

In step 1130, the video feeds are transformed into at least one video signal. Step 1130 may be performed in any of the ways described above, including combining the video feeds into a single video signal or into a video signal group including multiple video signals. Step 1130 may also include generating and providing any instructions for use by a receiver 620 in selectively processing a video signal.

In step 1140, the at least one video signal is provided for distribution over a television carrier channel associated with a television programming channel. Step 1140 may be performed in any of the ways described above, including content convergence subsystem 120 providing the at least one video signal and associated data (e.g., instructions) to content distribution subsystem 130.

In step 1150, the at least one video signal is distributed over the television carrier channel. Step 1150 may be performed in any of the ways described above.

In step 1160, the at least one video signal is received and processed with a receiver, including selectively providing one of the event views carried in the video signal(s) for display. Step 1160 may be performed in any of the ways described above, including in accordance with instructions provided to the receiver for selectively processing the video signal(s).

In step 1170, user input is received with the receiver. Step 1170 may be performed in any of the ways described above.

In step 1180, toggling between providing different ones of the event views for display is performed in response to the user input. Step 1180 may be performed in any of the ways described above, including the receiver switching its selective processing to process a different video signal and/or set of frames within a video signal.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
transforming a plurality of video feeds carrying data representative of a plurality of event views into at least one video signal;
distributing said at least one video signal over at least one television carrier channel associated with a television programming channel; and
receiving and processing said at least one video signal with a receiver to selectively provide one of said event views for display.

2. The method of claim 1, further comprising:
receiving user input with said receiver; and
toggling between providing different ones of said event views for display in association with said television programming channel and in response to said user input.

3. The method of claim 1, wherein said distributing includes at least one of multicasting and broadcasting said at least one video signal to a plurality of receivers over a subscriber television network.

4. The method of claim 1, wherein said plurality of event views comprises a plurality of player views associated with a multiplayer video game session.

5. The method of claim 4, further comprising:
receiving gaming data associated with said multiplayer video game session; and
using said gaming data to render said plurality of video feeds carrying data representative of said plurality of player views.

6. The method of claim 1, wherein said plurality of event views comprises a plurality of camera views associated with an event.

7. The method of claim 1, wherein said at least one video signal comprises at least one of a National Television Standards Committee (“NTSC”) based signal, an Advanced Television Systems Committee (“ATSC”) based signal, a Phase Alternating Line (“PAL”) based signal, a SECAM based signal, and a Digital Video Broadcasting (“DVB”) based signal.

8. The method of claim 1, tangibly embodied as computer-executable instructions on at least one computer-readable medium.

9. A method comprising:
combining a plurality of video feeds carrying data representative of a plurality of event views into a single video signal; and
providing said video signal for distribution over a television carrier channel.

10. The method of claim 9, further comprising:
distributing said video signal to a receiver over said television carrier channel; and
selectively processing said video signal with said receiver to selectively provide at least one of said event views for display.

11. The method of claim 10, further comprising generating and providing a key associated with said video signal for distribution over said television carrier channel, wherein said selectively providing said at least one of said event views for display is performed in accordance with said key.

12. The method of claim 11, wherein said providing said key comprises including data representative of said key in a closed captioning portion of said video signal.

13. The method of claim 11, wherein said key is configured to indicate a different set of frames in said video signal associated with each of said event views.

14. The method of claim 9, wherein said video signal includes a plurality of frames having at least a first set of frames associated with a first of said event views and a second set of frames associated with a second of said event views.

15. The method of claim 9, further comprising:
receiving said video signal over said television carrier channel with a receiver;
selectively providing one of said event views for display;
receiving user input with said receiver; and
selectively providing another of said event views for display in response to said user input.

16. The method of claim 9, wherein said combining includes multiplexing said video feeds into said video signal by frame rate.

17. A method comprising:
transforming a plurality of video feeds carrying data representative of a plurality of event views into a plurality of video signals; and
providing said plurality of video signals for distribution over a plurality of television carrier channels associated with a television programming channel.

18. The method of claim 17, further comprising:
distributing said plurality of video signals to a receiver over said plurality of television carrier channels;
instructing said receiver to alternate tuning between each of said television carrier channels in accordance with a set pattern; and
instructing said receiver to selectively perform display processing for only one of said video signals based on said set pattern.

19. The method of claim 18, wherein said instructing said receiver to selectively perform said display processing includes instructing said receiver to perform said display processing only within time periods during which said receiver is tuned to one of said television carrier channels corresponding to said one of said video signals.

20. The method of claim 18, further comprising:
receiving user input with said receiver; and
instructing said receiver to switch from selectively performing said display processing for only said one of said video signals to selectively performing said display processing for only another of said video signals based on said set pattern.

21. The method of claim 18, further comprising:
displaying one of said event views in association with said television programming channel;
receiving user input; and
displaying another of said event views in association with said television programming channel in response to said user input.

22. A system comprising:
a content convergence subsystem configured to transform content data into at least one video signal carrying data representative of a plurality of event views; and
a content distribution facility configured to receive said at least one video signal from said content convergence subsystem and to distribute said at least one video signal to a receiver over at least one television carrier channel associated with a television programming channel;
wherein said at least one video signal is configured to be received and selectively processed by said receiver such that one of said event views is selectively provided for display in association with said television programming channel.

23. The system of claim 22, wherein said at least one video signal is configured to be selectively processed by said receiver to toggle between providing different ones of said event views for display in association with said television programming channel and in response to user input received by said receiver.

24. The system of claim 22, wherein said at least one video signal comprises a single video signal and said at least one television carrier channel comprises a single television carrier channel associated with said television programming channel.

25. The system of claim 22, wherein said at least one video signal comprises a plurality of video signals and said at least one television carrier channel comprises a plurality of television carrier channels associated with said television programming channel.
